(19) United States
(12) Patent Application Publication
(10) Pub. No.: US 2020/0334687 A1
(43) Pub. Date: Oct. 22, 2020

(54) FRAUD TREND DETECTION AND LOSS MITIGATION

(71) Applicant: PayPal, Inc., San Jose, CA (US)

(72) Inventors: Shihao Ren, Shanghai (CN); Yingying Tao, Shanghai (CN); Chao Chen, Shanghai (CN); Huiwen Tao, Shanghai (CN); Fei Wang, Hangzhou (CN); Qian Wang, Hangzhou (CN)

(21) Appl. No.: 16/385,551

(22) Filed: Apr. 16, 2019

(51) Int. Cl. G06Q 30/00; G06Q 30/02; G06Q 10/06; G06N 20/00

(52) U.S. Cl. CPC G06Q 30/0185; G06N 20/00; G06Q 10/067; G06Q 30/0202

(57) ABSTRACT

Systems and techniques for providing fraud trend detection and/or loss mitigation are presented. A system can determine that transaction data satisfies a first defined criterion associated with a fraud trend and generates alert flow decision data based on the fraud trend. The system can also determine a subset of features from the alert flow decision data. Furthermore, the system can perform an algorithmic strategy technique based on the subset of features from the alert flow decision data to determine a fraud mitigation solution for the transaction data that satisfies a second defined criterion associated with a performance metric for the algorithmic strategy technique.

### TECHNICAL FIELD

This disclosure relates generally to transaction systems, and more specifically, to real-time fraud prevention associated with a transaction system (e.g., via employment of artificial intelligence).

### BACKGROUND

Detection of fraud in a transaction system is a difficult task. Currently, risk solutions to combat a fraud trend (e.g., a flash fraud trend, etc.) in a transaction system are generally manually composed after the fraud trend is detected. On average, manually composing a risk solution related to a fraud trend generally takes approximately one day to complete. Furthermore, if resource constraints and/or testing are employed to determine a risk solution related to a fraud trend, manually composing the risk solution could take an even longer amount of time. During this development period to determine a risk solution, a transaction system related to the fraud trend is highly likely to be negatively affected, performance of the transaction system is highly likely to be reduced, etc.

### BRIEF DESCRIPTION OF THE DRAWINGS

Numerous aspects, implementations, objects and advantages of the present invention will be apparent upon consideration of the following detailed description, taken in conjunction with the accompanying drawings, in which like reference characters refer to like parts throughout, and in which:

FIG. 1 illustrates a block diagram of an example, non-limiting system that includes a loss mitigation component in accordance with one or more embodiments described herein;

FIG. 2 illustrates a block diagram of another example, non-limiting system that includes a loss mitigation component in accordance with one or more embodiments described herein;

FIG. 3 illustrates an example, non-limiting system for providing fraud trend detection and/or loss mitigation in accordance with one or more embodiments described herein;

FIG. 4 illustrates another example, non-limiting system for providing fraud trend detection and/or loss mitigation in accordance with one or more embodiments described herein;

FIG. 5 illustrates an example, non-limiting system associated with a loss mitigation process in accordance with one or more embodiments described herein;

FIG. 6 illustrates an example, non-limiting system associated with a decision tree in accordance with one or more embodiments described herein;

FIG. 7 illustrates a flow diagram of an example, non-limiting method for providing fraud trend detection and/or loss mitigation in accordance with one or more embodiments described herein;

FIG. 8 illustrates a flow diagram of another example, non-limiting method for providing fraud trend detection and/or loss mitigation in accordance with one or more embodiments described herein;

FIG. 9 is a schematic block diagram illustrating a suitable operating environment; and

FIG. 10 is a schematic block diagram of a sample-computing environment.

### DETAILED DESCRIPTION

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without these specific details, or with other methods, components, materials, etc. In other instances, well-known structures and devices are shown in block diagram form to facilitate describing one or more aspects.

Systems and techniques for providing fraud trend detection and/or loss mitigation are presented. For instance, a fraud trend related to a transaction system can be detected automatically. Additionally or alternatively, loss related to the transaction system can be mitigated rapidly. Fraud trend detection and/or loss mitigation can be provided by employing automation in one or more steps for risk solution generation related to a fraud trend. As disclosed herein, a “fraud trend” can be undesirable behavior associated with transaction data and/or an online transaction system, where the undesirable behavior is associated with a computing device external to the online transaction system. In an embodiment, alerting related to a fraud trend, feature selection related to fraud detection, optimization for solution generation related to a fraud trend, and/or solution implementation related to a fraud trend can be provided. In an aspect, monitoring for a fraud trend can be performed and/or an alert can be generated in response to detection of a certain increase in activity related to a potential fraud trend. In certain embodiments, one or more alert candidates related to a potential fraud trend can be a combination of flow related variables associated with a potential fraud trend. Furthermore, potential loss for an online transaction system can be forecasted based on historical data and/or point in time data. In another aspect, feature selection can be performed based on the alert. For instance, feature selection can be performed based on the one or more alert candidates. The feature selection can be performed by selecting a set number of model scores and/or attribute variables from a variable data pool based on one or more metrics associated with the flow related variables. In an example, feature selection can be performed by selecting a set number of model scores and/or attribute variables from a variable data pool based on an information value associated with a weighted sum of one or more characteristics for the flow related variables. In yet another aspect, a search algorithm can be employed with respect to one or more features selected by the feature selection to determine an optimal risk solution for the potential fraud trend with one or more performance metrics being satisfied. For example, a greedy search algorithm can be employed with respect to the one or more features selected by the feature selection to determine the optimal risk solution for the potential fraud trend. In yet another aspect, one or more alert flows and/or corresponding risk solutions can be provided to a decision engine via a data tunnel. For instance, one or more alert flows and/or corresponding risk solutions can be provided to a decision engine via a remotely addressable communication channel. In one example, the data tunnel can from transmit data from an offline data table to an online computing environment associated with a decision engine. In certain embodiments, one or more predefined rules can employ the one or more alert flows and/or corresponding risk solutions to configure a specific fraud trend with a customized risk solution for the potential fraud trend.

As such, a fraud trend associated with an online transaction system can be accurately detected. An amount of time to detect a fraud trend associated with an online transaction system can also be reduced. Furthermore, loss associated with an online transaction system in response to a fraud trend can be mitigated. In addition, security associated with an online transaction system can be improved. Moreover, reliability of execution of a transaction by an online transaction system can be improved, performance of an online transaction system can be improved, and/or a computing experience associated with an online transaction system can be improved.

According to an embodiment, a system can include a fraud monitoring component, a feature selection component, and an optimization component. The fraud monitoring component can determine that transaction data satisfies a first defined criterion associated with a fraud trend and generates alert flow decision data based on the fraud trend. The feature selection component can determine a subset of features from the alert flow decision data. The optimization component can perform an algorithmic strategy technique based on the subset of features from the alert flow decision data to determine a fraud mitigation solution for the transaction data that satisfies a second defined criterion associated with a performance metric for the algorithmic strategy technique.

In another embodiment, a method can provide for monitoring, by a system operatively coupled to a processor, transaction data in response to a determination that the transaction data satisfies a first defined criterion. The method can also provide for generating, by the system, a set of alert candidates associated with a combination of flow related variables based on the monitoring of the transaction data. The method can also provide for determining, by the system, a subset of features from the set of alert candidates based on metrics data associated with the set of alert candidates. Furthermore, the method can provide for performing, by the system, an algorithmic strategy technique based on the subset of features from the set of alert candidates to determine a fraud mitigation solution for the transaction data that satisfies a second defined criterion associated with a performance metric for the algorithmic strategy technique.

In yet another embodiment, a computer readable storage device can comprise instructions that, in response to execution, cause a system comprising a processor to perform operations, comprising: generating a set of alert candidates associated with a set of flow related variables for transaction data based on monitoring data associated with the transaction data, determining a subset of features from the set of alert candidates based on metrics data associated with the set of alert candidates, performing an algorithmic strategy technique based on the subset of features from the set of alert candidates to determine a fraud mitigation solution for the transaction data that satisfies a defined criterion associated with a performance metric for the algorithmic strategy technique, and transmitting the fraud mitigation solution to a server device associated with a decision engine via a secure communication channel.

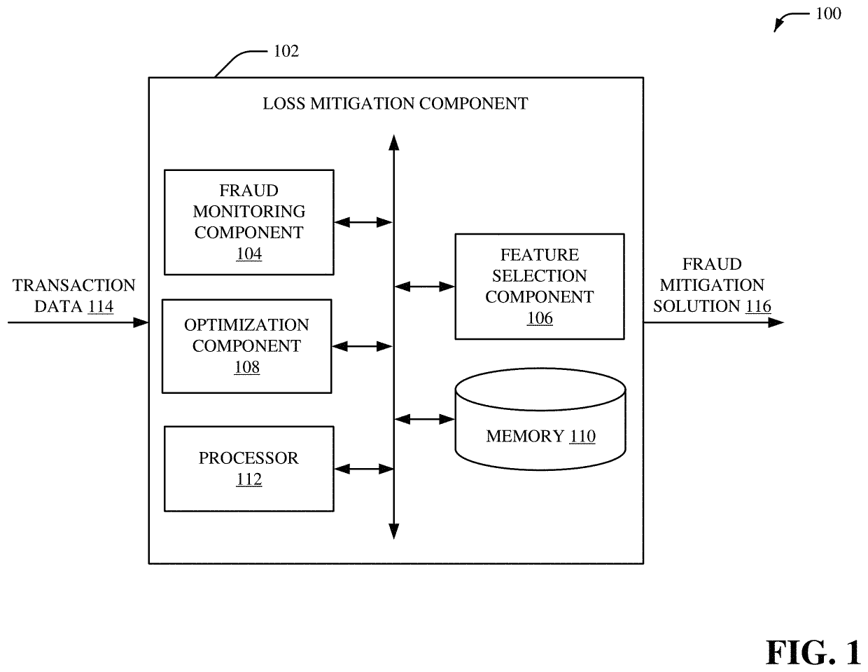

Referring initially to FIG. 1, there is illustrated an example system 100 that provides fraud trend detection and/or loss mitigation, in accordance with one or more embodiments described herein. The system 100 can be implemented on or in connection with a network of servers associated with an enterprise application. In one example, the system 100 can be associated with a cloud-based platform. In an embodiment, the system 100 can be associated with a computing environment that comprises one or more servers and/or one or more software components that operate to perform one or more processes, one or more functions and/or one or more methodologies in accordance with the described embodiments. A sever as disclosed herein can include, for example, stand-alone server and/or an enterprise-class server operating a server operating system (OS) such as a MICROSOFT® OS, a UNIX® OS, a LINUX® OS, and/or another suitable server-based OS. It is to be appreciated that one or more operations performed by a server and/or one or more services provided by a server can be combined, distributed, and/or separated for a given implementation. Furthermore, one or more servers can be operated and/or maintained by a corresponding entity or different entities.

The system 100 can be employed by various systems, such as, but not limited to fraud prevention systems, risk management systems, transaction systems, payment systems, online transaction systems, online payment systems, server systems, electronic device systems, mobile device systems, smartphone systems, virtual machine systems, consumer service systems, security systems, mobile application systems, financial systems, digital systems, machine learning systems, artificial intelligence systems, neural network systems, network systems, computer network systems, communication systems, enterprise systems, and the like. In one example, the system 100 can be associated with a Platform-as-a-Service (PaaS) and/or a transaction system. Moreover, the system 100 and/or the components of the system 100 can be employed to use hardware and/or software to solve problems that are highly technical in nature (e.g., related to artificial intelligence, related to machine learning, related to digital data processing, etc.), that are not abstract and that cannot be performed as a set of mental acts by a human.

The system 100 includes a loss mitigation component 102. In FIG. 1, the loss mitigation component 102 can include a fraud monitoring component 104, a feature selection component 106, and/or an optimization component 108. Aspects of the systems, apparatuses or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described. The system 100 (e.g., the loss mitigation component 102) can include memory 110 for storing computer executable components and instructions. The system 100 (e.g., the loss mitigation component 102) can further include a processor 112 to facilitate operation of the instructions (e.g., computer executable components and instructions) by the system 100 (e.g., the loss mitigation component 102).

The loss mitigation component 102 (e.g., the fraud monitoring component 104 of the loss mitigation component 102) can receive transaction data 114. The transaction data 114 can be data related to one or more transactions associated with one or more computing devices. The transaction data 114 can also be associated with one or more events (e.g., one or more transaction events) associated with one or more computing devices. In an aspect, an event associated with the transaction data 114 can include a numerical value corresponding to an amount for a transaction. Additionally or alternatively, an event associated with the transaction data 114 can include time data related to a timestamp for the transaction. An event associated with the transaction data 114 can additionally or alternatively include an item associated with the transaction and/or an identifier for one or more entities associated with the transaction. In certain embodiments, the transaction data 114 can be financial transaction data. For example, the transaction data 114 can be data to facilitate a transfer of funds for transactions between two entities. The one or more computing devices associated with the transaction data 114 can be one or more client devices, one or more user devices, one or more electronic devices one or more mobile devices, one or more smart devices, one or more smart phones, one or more tablet devices, one or more handheld devices, one or more portable computing devices, one or more wearable devices, one or more computers, one or more desktop computers, one or more laptop computers, and/or one or more other types of electronic devices associated with a display.

The fraud monitoring component 104 can monitor the transaction data 114 to determine whether the transaction data 114 satisfies a defined criterion associated with a fraud trend. The fraud trend can be, for example, undesirable behavior associated with transaction data 114. For instance, the fraud trend can correspond to one or more patterns associated with the transaction data 114. The fraud monitoring component 104 can employ a set of monitoring criteria to determine whether the transaction data 114 satisfies a defined criterion associated with a fraud trend. For example, the fraud monitoring component 104 can monitor data values and/or patterns related to the transaction data 114. In an embodiment, the fraud monitoring component 104 can determine that the transaction data 114 satisfies the defined criterion associated with the fraud trend. Furthermore, the fraud monitoring component 104 can generate alert flow decision data based on the fraud trend. For instance, in response to determining that the transaction data 114 satisfies the defined criterion associated with the fraud trend, the fraud monitoring component 104 can generate the alert flow decision data based on the fraud trend. The alert flow decision data can include a set of alert candidates associated with the transaction data 114. For example, the set of alert candidates from the alert flow decision data can be combinations of flow related variables associated with the transaction data 114. In certain embodiments, the set of alert candidates from the alert flow decision data can be constructed as a decision tree with different combinations of flow related variables associated with the transaction data 114.

In certain embodiments, to facilitate monitoring the transaction data 114 and/or generating the alert flow decision data, the fraud monitoring component 104 can perform learning with respect to the transaction data 114. The fraud monitoring component 104 can also generate inferences with respect to the transaction data 114. The fraud monitoring component 104 can, for example, employ principles of artificial intelligence to facilitate monitoring the transaction data 114 and/or generating the alert flow decision data. The fraud monitoring component 104 can perform learning with respect to the transaction data 114 explicitly or implicitly. Additionally or alternatively, the fraud monitoring component 104 can also employ an automatic classification system and/or an automatic classification process to facilitate monitoring the transaction data 114. For example, the fraud monitoring component 104 can employ a probabilistic and/or statistical-based analysis (e.g., factoring into the analysis utilities and costs) to learn and/or generate inferences with respect to the transaction data 114. The fraud monitoring component 104 can employ, for example, a support vector machine (SVM) classifier to learn and/or generate inferences with respect to the transaction data 114. Additionally or alternatively, the fraud monitoring component 104 can employ other classification techniques associated with Bayesian networks, decision trees and/or probabilistic classification models. Classifiers employed by the fraud monitoring component 104 can be explicitly trained (e.g., via a generic training data) as well as implicitly trained (e.g., via observing user behavior, receiving extrinsic information). For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

In an aspect, the fraud monitoring component 104 can include an inference component that can further enhance automated aspects of the fraud monitoring component 104 utilizing in part inference-based schemes to facilitate monitoring the transaction data 114. The fraud monitoring component 104 can employ any suitable machine-learning based techniques, statistical-based techniques and/or probabilistic-based techniques. For example, the fraud monitoring component 104 can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, etc. In another aspect, the fraud monitoring component 104 can perform a set of machine learning computations associated with the transaction data 114. For example, the fraud monitoring component 104 can perform a set of clustering machine learning computations, a set of decision tree machine learning computations, a set of instance-based machine learning computations, a set of regression machine learning computations, a set of regularization machine learning computations, a set of rule learning machine learning computations, a set of Bayesian machine learning computations, a set of deep Boltzmann machine computations, a set of deep belief network computations, a set of convolution neural network computations, a set of stacked auto-encoder computations and/or a set of different machine learning computations.

The feature selection component 106 can determine a subset of features from the alert flow decision data. For instance, the feature selection component 106 can determine a subset of features from the alert flow decision data based on metrics data associated with the alert flow decision data. The metrics data can include statistical data for the alert flow decision data. In one example, the metrics data can include a set of information values for the alert flow decision data. An information value can be, for example, a sum of values for features associated with a weight of evidence score. Additionally or alternatively, the metrics data can include a set of logistic regression values for the alert flow decision data. A logistic regression value can be, for example, a statistical value that employs a logistic function to model a portion of the alert flow decision data. Additionally or alternatively, the metrics data can include data associated with decision tree learning such as, for example, an iterative Dichotomiser 3 algorithm, a C4.5 algorithm, a classification and regression trees algorithm, and/or another decision tree learning algorithm.

In certain embodiments, to facilitate determining the subset of features from the alert flow decision data, the feature selection component 106 can perform learning with respect to the alert flow decision data. The feature selection component 106 can also generate inferences with respect to the alert flow decision data. The feature selection component 106 can, for example, employ principles of artificial intelligence to facilitate determining the subset of features from the alert flow decision data. The feature selection component 106 can perform learning with respect to the alert flow decision data explicitly or implicitly. Additionally or alternatively, the feature selection component 106 can also employ an automatic classification system and/or an automatic classification process to facilitate determining the subset of features from the alert flow decision data. For example, the feature selection component 106 can employ a probabilistic and/or statistical-based analysis (e.g., factoring into the analysis utilities and costs) to learn and/or generate inferences with respect to the alert flow decision data. The feature selection component 106 can employ, for example, a SVM classifier to learn and/or generate inferences with respect to the alert flow decision data. Additionally or alternatively, the feature selection component 106 can employ other classification techniques associated with Bayesian networks, decision trees and/or probabilistic classification models. Classifiers employed by the feature selection component 106 can be explicitly trained (e.g., via a generic training data) as well as implicitly trained (e.g., via observing user behavior, receiving extrinsic information). For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

In an aspect, the feature selection component 106 can include an inference component that can further enhance automated aspects of the feature selection component 106 utilizing in part inference-based schemes to facilitate determining the subset of features from the alert flow decision data. The feature selection component 106 can employ any suitable machine-learning based techniques, statistical-based techniques and/or probabilistic-based techniques. For example, the feature selection component 106 can employ expert systems, fuzzy logic, SVMs, HMMs, greedy search algorithms, rule-based systems, Bayesian models (e.g., Bayesian networks), neural networks, other non-linear training techniques, data fusion, utility-based analytical systems, systems employing Bayesian models, etc. In another aspect, the feature selection component 106 can perform a set of machine learning computations associated with the alert flow decision data. For example, the feature selection component 106 can perform a set of clustering machine learning computations, a set of decision tree machine learning computations, a set of instance-based machine learning computations, a set of regression machine learning computations, a set of regularization machine learning computations, a set of rule learning machine learning computations, a set of Bayesian machine learning computations, a set of deep Boltzmann machine computations, a set of deep belief network computations, a set of convolution neural network computations, a set of stacked auto-encoder computations and/or a set of different machine learning computations.

The optimization component 108 can perform an algorithmic strategy technique based on the subset of features from the alert flow decision data to determine a fraud mitigation solution 116 for the transaction data. For instance, in an embodiment, the optimization component 108 can perform an algorithmic strategy technique based on the subset of features from the alert flow decision data to determine the fraud mitigation solution 116 for the transaction data that satisfies a defined criterion associated with a performance metric for the algorithmic strategy technique. In an embodiment, the optimization component 108 can perform a greedy search algorithmic technique based on the subset of features from the alert flow decision data to determine the fraud mitigation solution for the transaction data 114. For example, the greedy search algorithmic technique can employ a heuristic approach to determine optimal decisions associated with a decision tree. The fraud mitigation solution 116 can be a solution mitigate an effect of the fraud trend on an online transaction system. For instance, the fraud mitigation solution 116 can be one or more actions to perform to modify one or more portions of the online transaction system, thereby mitigating loss associated with the fraud trend. In an example, the fraud mitigation solution 116 can include one or more options of score cutoffs and/or variable value combinations considering different criteria for the online transaction system. In an embodiment, the optimization component 108 can select the fraud mitigation solution 116 from a set of fraud mitigation solutions. For example, the fraud mitigation solution 116 can be a fraud mitigation solution with an optimal model score as compared to one or more other fraud mitigation solutions. In certain embodiments, the feature selection component 106 can determine a set of model scores and/or a set of attribute variables from a set of data pools associated with the alert flow decision data. Furthermore, the optimization component 108 can perform the algorithmic strategy technique based on the set of model scores and the set of attribute variables to determine the fraud mitigation solution for the transaction data 114. In certain embodiments, the fraud monitoring component 104 can generate loss forecast data associated with the fraud trend. The loss forecast data can forecast potential loss for an online transaction system in response to the fraud trend. For example, the loss forecast data can calculate mature rate by flows and/or loss mature time associated with the transaction data 114. The loss forecast data can also forecast a fraud trend by applying the mature rate. In an aspect, the loss forecast data can employ a variable list for alerting based on location data, transaction type data, computing device data, verification data, encryption data, transaction source data, third-party data and/or other data. In an embodiment, the fraud monitoring component 104 can generate the loss forecast data associated with the fraud trend based on historical data. The historical data can include historical information associated with one or more previous fraud trends. For example, the historical data can include historical values and/or historical patterns for previous transaction data associated with a fraud trend. Additionally or alternatively, the fraud monitoring component 104 can generate the loss forecast data associated with the fraud trend based on point-in-time data associated with the transaction data 114. The point-in-time data can be a snapshot of previous transaction data associated with one or more previous fraud trends. For example, the point-in-time data can be a copy of previous transaction data associated with one or more previous fraud trends. Furthermore, in certain embodiments, the feature selection component 106 can determine the subset of features from the alert flow decision data based on the loss forecast data.

Compared to a conventional system, the loss mitigation component 102 can provide improved detection of a fraud trend associated with transaction data and/or an online transaction system. Additionally, by employing the loss mitigation component 102, loss associated with an online transaction system can be mitigated, security associated with an online transaction system can be improved, reliability of execution of a transaction by an online transaction system can be improved, performance of an online transaction system can be improved, and/or a computing experience associated with an online transaction system can be improved. Moreover, it is to be appreciated that technical features of the loss mitigation component 102 and management of a login loss mitigation process, etc. are highly technical in nature and not abstract ideas. Processing threads of the loss mitigation component 102 that process the transaction data 114 cannot be performed by a human (e.g., are greater than the capability of a single human mind). For example, the amount of the transaction data 114 processed, the speed of processing of the transaction data 114 and/or the data types of the transaction data 114 analyzed by the loss mitigation component 102 over a certain period of time can be respectively greater, faster and different than the amount, speed and data type that can be processed by a single human mind over the same period of time. Furthermore, the transaction data 114 analyzed by the loss mitigation component 102 can be encoded data and/or compressed data associated with one or more computing devices. Moreover, the loss mitigation component 102 can be fully operational towards performing one or more other functions (e.g., fully powered on, fully executed, etc.) while also analyzing the transaction data 114.

While FIG. 1 depicts separate components in the loss mitigation component 102, it is to be appreciated that two or more components may be implemented in a common component. Further, it can be appreciated that the design of system 100 and/or the loss mitigation component 102 can include other component selections, component placements, etc., to facilitate fraud trend detection and/or loss mitigation.

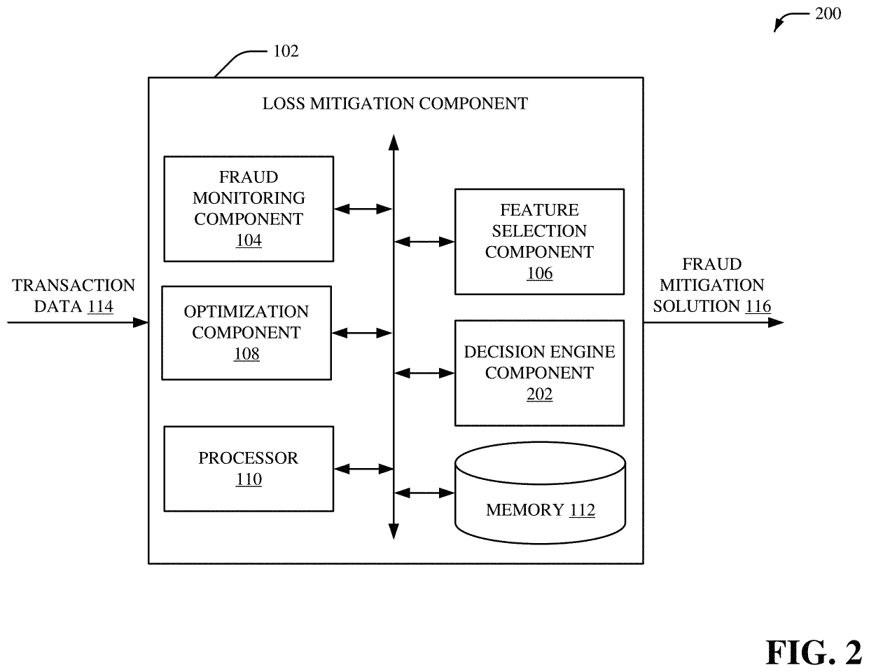

FIG. 2 illustrates an example, non-limiting system 200 in accordance with one or more embodiments described herein. Repetitive description of like elements employed in other embodiments described herein is omitted for sake of brevity. The system 200 includes the loss mitigation component 102. In FIG. 2, the loss mitigation component 102 can include the fraud monitoring component 104, the feature selection component 106, the optimization component 108, and/or a decision engine component 202. The decision engine component 202 can transmit the fraud mitigation solution 116 to a server associated with a decision engine via a data channel (e.g., a communication channel) associated with a tunneling protocol. In certain embodiment, the decision engine component 202 can encode and/or encrypt the fraud mitigation solution 116 for transmission via the data channel associated with the tunneling protocol. The tunneling protocol can be associated with real-time repetitive transmission of data. In an embodiment, the decision engine component 202 can transmit the fraud mitigation solution 116 to the server associated with the decision engine via a data channel Additionally or alternatively, the decision engine component 202 can transmit the alert flow decision data to the server associated with the decision engine via the data channel associated with the tunneling protocol. The decision engine in communication with the decision engine component 202 can be configured to perform one or more actions associated with the fraud mitigation solution 116. In certain embodiments, the decision engine component 202 can repeatedly update a tunneling protocol for the data channel during an interval of time. For example, the tunneling protocol employed to transmit the fraud mitigation solution 116 can be updated hourly, daily, weekly, etc. by the decision engine component 202.

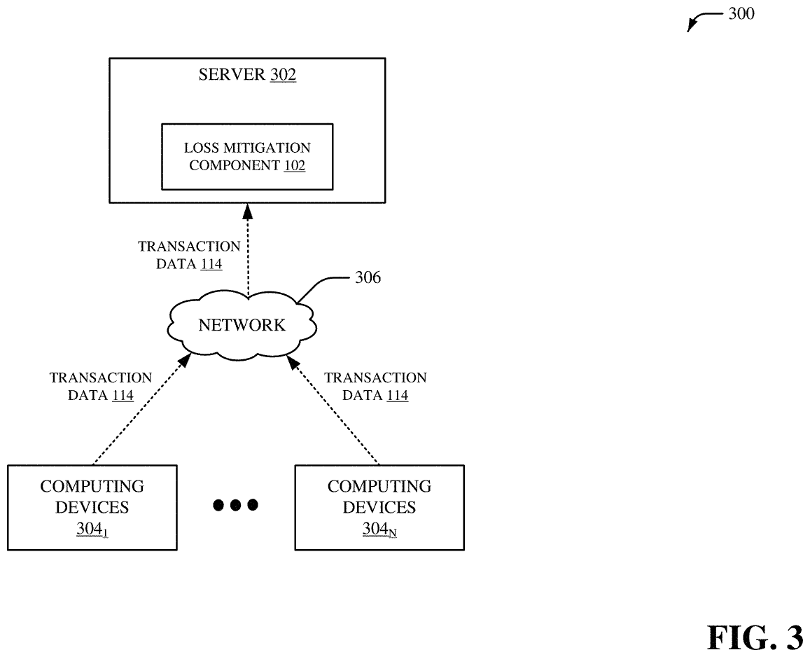

FIG. 3 illustrates an example, non-limiting system 300 in accordance with one or more embodiments described herein. Repetitive description of like elements employed in other embodiments described herein is omitted for sake of brevity. The system 300 includes a server 302 and one or more computing devices 304_{1-N}, where N is an integer. The server 302 can include the loss mitigation component 102. The server 302 and the one or more computing devices 304_{1-N} can be in communication via a network 306. The network 306 can be a communication network, a wireless network, an internet protocol (IP) network, a voice over IP network, an internet telephony network, a mobile telecommunications network, a landline telephone network, a personal area network, a wired network, and/or another type of network. The server 302 can be, for example, a stand-alone server and/or an enterprise-class server operating a server OS such as a MICROSOFT® OS, a UNIX® OS, a LINUX® OS, and/or another suitable server-based OS. It is to be appreciated that one or more operations performed by the server 302 and/or one or more services provided by the server 302 can be combined, distributed, and/or separated for a given implementation. Furthermore, the server 302 can be associated with a transaction system, a payment system, an online transaction system, an online payment system, an enterprise system, and/or another type of system.

The one or more computing devices 304_{1-N} can be one or more client devices, one or more user devices, one or more electronic devices one or more mobile devices, one or more smart devices, one or more smart phones, one or more tablet devices, one or more handheld devices, one or more portable computing devices, one or more wearable devices, one or more computers, one or more desktop computers, one or more laptop computers, and/or one or more other types of electronic devices associated with a display. Furthermore, the one or more computing devices 304_{1-N} can respectively include one or more computing capabilities and/or one or more communication capabilities. In an aspect, the one or more computing devices 304_{1-N} can respectively provide one or more electronic device programs, such as system programs and application programs to perform various computing and/or communications operations. Some example system programs associated with the one or more computing devices 304_{1-N} can include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Some example application programs associated with the one or more computing devices 304_{1-N} can include, without limitation, a web browser application, a transaction application, a messaging application (e.g., e-mail, IM, SMS, MMS, telephone, voicemail, VoIP, video messaging, internet relay chat (IRC)), a contacts application, a calendar application, an electronic document application, a database application, a media application (e.g., music, video, television), a location-based services (LBS) application (e.g., GPS, mapping, directions, positioning systems, geolocation, point-of-interest, locator) that may utilize hardware components such as an antenna, and so forth. One or more of the electronic device programs associated with the one or more computing devices 304_{1-N} can display a graphical user interface to present information to and/or receive information from one or more users of the one or more computing devices 304_{1-N}. In some embodiments, the electronic device programs associated with the one or more computing devices 304_{1-N} can include one or more applications configured to execute and/or conduct a transaction associated with the transaction data 114. In an embodiment, an application program associated with the one or more computing devices 304_{1-N} can be related to a transaction system, a payment system, an online transaction system, an online payment system, an enterprise system, and/or another type of system associated with the server 302.

In an embodiment, the server 302 that includes the loss mitigation component 102 can receive the transaction data 114 via the network 406. For example, the server 302 that includes the loss mitigation component 102 can receive the transaction data 114 from the one or more computing devices 304_{1-N}. The one or more computing devices 304_{1-N} can generate at least a portion of the transaction data 114. Furthermore, one or more computing devices from the one or more computing devices 304_{1-N} can be a source of a fraud trend. For example, one or more computing devices from the one or more computing devices 304_{1-N} can provide undesirable behavior associated with the transaction data 114. In another embodiment, the loss mitigation component 102 of the server 302 can monitor the transaction data 114 for a fraud trend and can generate fraud mitigation solution 116 to mitigate a fraud trend associated with the transaction data 114, as more fully disclosed herein. As such, with the system 300, detection of a fraud trend associated with the transaction data 114 and/or the one or more computing devices 304_{1-N} can be improved. Additionally, by employing the system 300, loss associated with the server 302 can be mitigated, security associated with the server 302 can be improved, reliability of execution of a transaction by the server 302 can be improved, performance of the server 302 can be improved, and/or a computing experience associated with the server 302 can be improved. Additionally, with the system 300, reliability of execution of a transaction by the server 302 can be improved.

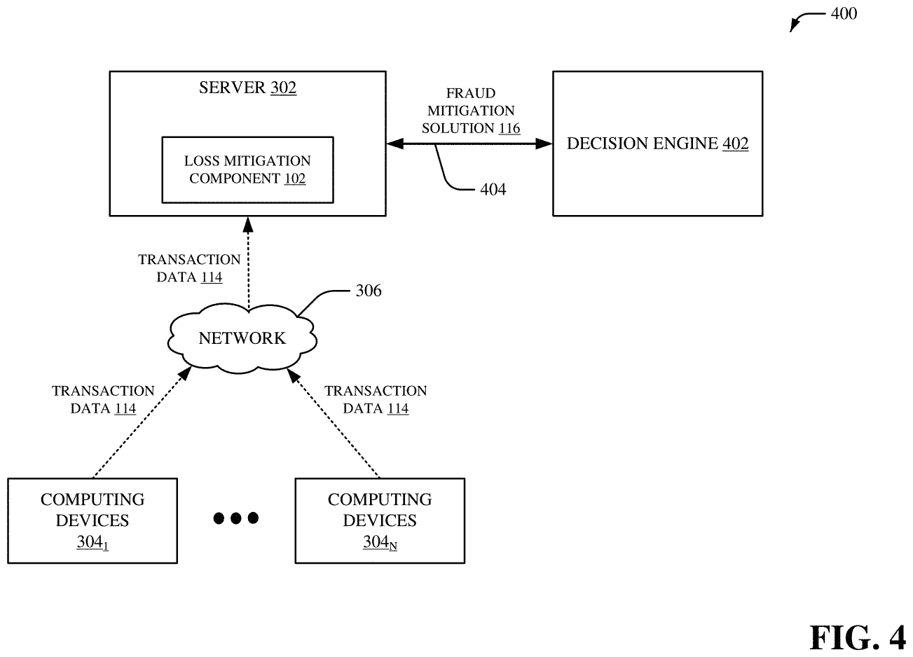

FIG. 4 illustrates an example, non-limiting system 400 in accordance with one or more embodiments described herein. Repetitive description of like elements employed in other embodiments described herein is omitted for sake of brevity. The system 400 includes the server 302, the one or more computing devices 304_{1-N}, and a decision engine 402. The server 302 can include the loss mitigation component 102. The server 302 and the one or more computing devices 304_{1-N} can be in communication via the network 306. Furthermore, the server 302 that includes the loss mitigation component 102 can be in communication with the decision engine 402 via a data channel 404. The data channel 404 can be associated with one or more tunneling protocols. For example, data can be transmitted between the server 302 and the decision engine 402 via one or more tunneling protocols that secure transmission of the data. In an embodiment, the data channel 404 can be a remotely addressable communication channel. Furthermore, in an aspect, the data channel 404 can be a data channel that converts data (e.g., the transaction data 114) from an offline data table associated with the server 302 to an online computing environment associated with the decision engine 402. In certain embodiments, the data channel 404 can facilitate risk analytics associated with the transaction data 114. In certain embodiments, a set of data tables associated with persistent memory and/or data compression for the transaction data 114 can be access by the data channel 404. The decision engine 402 can receive the fraud mitigation solution 116, for example, via the data channel 404. In an embodiment, the decision engine 402 can be a server that executes the fraud mitigation solution 116. For example, the decision engine 402 can be a stand-alone server and/or an enterprise-class server operating a server OS such as a MICROSOFT® OS, a UNIX® OS, a LINUX® OS, and/or another suitable server-based OS. It is to be appreciated that one or more operations performed by the decision engine 402 and/or one or more services provided by the decision engine 402 can be combined, distributed, and/or separated for a given implementation. Furthermore, the decision engine 402 can be associated with a transaction system, a payment system, an online transaction system, an online payment system, an enterprise system, and/or another type of system.

In certain embodiments, the decision engine 402 can employ one or more artificial intelligence techniques to execute the fraud mitigation solution 116. For example, the decision engine 402 can employ one or more artificial intelligence techniques to execute one or more actions associated with the fraud mitigation solution 116. In an aspect, to facilitate executing the fraud mitigation solution 116, the decision engine 402 can include an inference component that can further enhance automated aspects of the decision engine 402 utilizing in part inference-based schemes. The decision engine 402 can employ any suitable machine-learning based techniques, statistical-based techniques and/or probabilistic-based techniques. For example, the decision engine 402 can employ expert systems, fuzzy logic, SVMs, HMMs, greedy search algorithms, rule-based systems, Bayesian models (e.g., Bayesian networks), neural networks, other non-linear training techniques, data fusion, utility-based analytical systems, systems employing Bayesian models, etc. In another aspect, the decision engine 402 can perform a set of machine learning computations associated with the fraud mitigation solution 116. For example, the decision engine 402 can perform a set of clustering machine learning computations, a set of decision tree machine learning computations, a set of instance-based machine learning computations, a set of regression machine learning computations, a set of regularization machine learning computations, a set of rule learning machine learning computations, a set of Bayesian machine learning computations, a set of deep Boltzmann machine computations, a set of deep belief network computations, a set of convolution neural network computations, a set of stacked auto-encoder computations and/or a set of different machine learning computations. As such, with the system 400, detection of a fraud trend associated with the transaction data 114 and/or the one or more computing devices 304_{1-N} can be improved. Additionally, by employing the system 400, loss associated with the server 302 can be mitigated, security associated with the server 302 can be improved, reliability of execution of a transaction by the server 302 can be improved, performance of the server 302 can be improved, and/or a computing experience associated with the server 302 can be improved. Additionally, with the system 400, reliability of execution of a transaction by the server 302 can be improved.

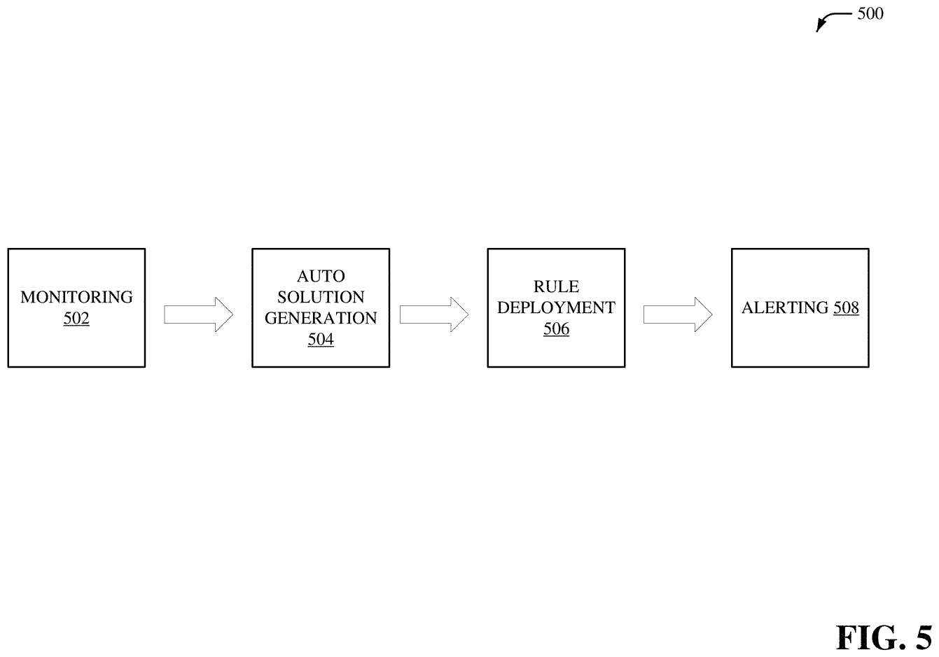

FIG. 5 illustrates an example, non-limiting system 500 in accordance with one or more embodiments described herein. Repetitive description of like elements employed in other embodiments described herein is omitted for sake of brevity. The system 500 can be associated with a loss mitigation process performed by the loss mitigation component 102. For example, the system 500 can be employed to detect a fraud trend in an early stage and/or to launch an auto solution to prevent the fraud trend and to mitigate loss. The system 500 includes monitoring 502, auto solution generation 504, rule deployment 506, and/or alerting 508. The monitoring 502, the auto solution generation 504, the rule deployment 506, and/or the alerting 508 can facilitate fraud trend detection and/or loss mitigation associated with the transaction data 114.

The monitoring 502 can be an alerting process performed by the fraud monitoring component 104. For instance, the monitoring 502 can facilitate determining whether the transaction data 114 satisfies a defined criterion associated with a fraud trend. In an aspect, the monitoring 502 can monitor the transaction data 114 based on a set of variables (e.g., a variable list) associated with one or more features for the transaction data 114. In another aspect, the monitoring 502 can employ alert criteria to identify an increase in certain activity related to the transaction data 114. In certain embodiments, the monitoring 502 can generate one or more decision trees associated with the transaction data 114. For example, the monitoring 502 can generate one or more tree-like models of decisions related to the transaction data 114. In certain embodiments, the monitoring 502 can select a decision tree from a set of decision trees with a largest alerting loss coverage. Furthermore, the monitoring 502 can determine and/or provide alert flow decision data (e.g., one or more alerting flows) from the decision tree selected from the set of decision trees.

The auto solution generation 504 can be an auto solution generation process performed by the feature selection component 106. The auto solution generation 504 can generate a risk solution related to a fraud trend associated with the transaction data 114. In an embodiment, the auto solution generation 504 can perform feature selection associated with the alert flow decision data (e.g., the one or more alerting flows). For example, the auto solution generation 504 can perform the feature selection to obtain one or more variables from the alert flow decision data (e.g., the one or more alerting flows). In an aspect, the auto solution generation 504 can perform the feature selection to obtain the one or more variables from asset of variable pools associated with the alert flow decision data (e.g., the one or more alerting flows). In another aspect, the auto solution generation 504 can perform the feature selection to determine a subset of features from the alert flow decision data (e.g., the one or more alerting flows). In certain embodiments, the auto solution generation 504 can perform the feature selection based on an algorithmic strategy technique. For example, the auto solution generation 504 can perform the feature selection based on a greedy search algorithmic technique. In an example, the algorithmic strategy technique can provide one or more options of score cutoff and/or variable value combination based on one or more requirements for an online transaction system associated with the transaction data 114.

The rule deployment 506 can be a rule deployment process performed by the optimization component 108 and/or the decision engine component 202. The rule deployment 506 can be performed to facilitate determination of a fraud mitigation solution for the transaction data 114. For example, the rule deployment 506 can deploy one or more rules associated with an algorithmic strategy technique to facilitate determination of a fraud mitigation solution for the transaction data 114. In an embodiment, the rule deployment 506 can perform the algorithmic strategy technique based on a subset of features from the alert flow decision data to determine a fraud mitigation solution for the transaction data 114. In certain embodiments, the rule deployment 506 can transmits a fraud mitigation solution to a server associated with a decision engine via a data channel associated with a tunneling protocol. For example, the rule deployment 506 can transmits a fraud mitigation solution to a server associated with a decision engine via a remotely addressable communication channel In an embodiment, the rule deployment 506 can repeatedly update a tunneling protocol for the communication channel during an interval of time. For example, the tunneling protocol employed by the rule deployment 506 can be updated hourly, daily, weekly, etc.

The alerting 508 can be an alerting process performed by the optimization component 108 and/or the decision engine component 202. For example, the alerting 508 can additionally or alternatively transmit the alert flow decision data (e.g., the one or more alerting flows) to a server associated with a decision engine via a data channel associated with a tunneling protocol. In certain embodiments, the alerting 508 can generate one or more reports associated with one or more fraud mitigation solutions and/or one or more alerting flows. Additionally or alternatively, the alerting 508 can generate one or more reports associated with one or more rules related to one or more algorithmic strategies.

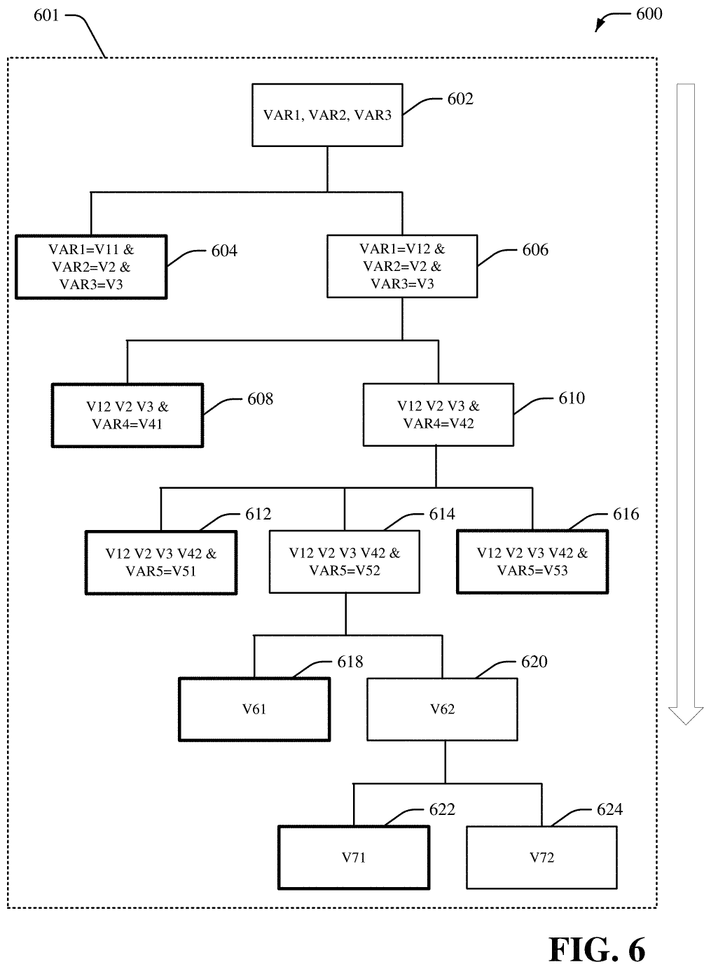

FIG. 6 illustrates an example, non-limiting system 600 in accordance with one or more embodiments described herein. Repetitive description of like elements employed in other embodiments described herein is omitted for sake of brevity. The system 600 includes a decision tree 601. The decision tree 601 can include data group 602, data group 604, data group 606, data group 608, data group 610, data group 612, data group 614, data group 616, data group 618, data group 620, data group 622, and data group 624. For example, the fraud monitoring component 104 can split the transaction data 114 into the data group 602, the data group 604, the data group 606, the data group 608, the data group 610, the data group 612, the data group 614, the data group 616, the data group 618, the data group 620, the data group 622, and the data group 624 to form different pockets of data associated with the transaction data 114. Furthermore, the data group 602, the data group 604, the data group 606, the data group 608, the data group 610, the data group 612, the data group 614, the data group 616, the data group 618, the data group 620, the data group 622, and the data group 624 can respectively include a unique grouping of monitoring variables associated with the transaction data 114.

In an aspect, alert criteria can be applied to the data group 602, the data group 604, the data group 606, the data group 608, the data group 610, the data group 612, the data group 614, the data group 616, the data group 618, the data group 620, the data group 622, and the data group 624. Furthermore, one or more data groups from the data group 602, the data group 604, the data group 606, the data group 608, the data group 610, the data group 612, the data group 614, the data group 616, the data group 618, the data group 620, the data group 622, and the data group 624 that satisfy a defined criteria can be identified. For instance, one or more data groups from the data group 602, the data group 604, the data group 606, the data group 608, the data group 610, the data group 612, the data group 614, the data group 616, the data group 618, the data group 620, the data group 622, and the data group 624 that exhibit a potential fraud trend can be identified. In one example, the data group 604, the data group 608, the data group 612, the data group 616, the data group 618 and the data group 622 can satisfy a defined criterion associated with a fraud trend. In another example, the monitoring variables associated with the data group 602, the data group 604, the data group 606, the data group 608, the data group 610, the data group 612, the data group 614, the data group 616, the data group 618, the data group 620, the data group 622, and the data group 624 can include a first monitoring variable var1, a second monitoring variable var2, a third monitoring variable var3, a fourth monitoring variable var4, a fifth monitoring variable vary, a sixth monitoring variable var6, and a seventh monitoring variable var7. The fraud monitoring component 104 can begin monitoring with a minimal number of monitoring variable combinations. Furthermore, the fraud monitoring component 104 can add a monitoring variable each time if an alert criterion is not met, until all the monitoring variables are employed to describe a data group.

In certain embodiments, the fraud monitoring component 104 can loop one or more possible sequences of the monitoring variables through the decision tree 601. The fraud monitoring component 104 can also select, for example, the best sequence with a largest gross loss coverage. In an embodiment, the decision tree 601 can be a tree-like model of decisions related to the transaction data 114. Additionally, the fraud monitoring component 104 can generate alert flow decision data (e.g., one or more alerting flows) associated with the decision tree 601. In another embodiment, the feature selection component 106 can determine a subset of features from the alert flow decision data (e.g., one or more alerting flows) associated with the decision tree 601. For instance, the subset of features can correspond to monitoring variables from the data group 604, the data group 608, the data group 612, the data group 616, the data group 618 and the data group 622 that satisfy the defined criterion associated with a fraud trend. In yet another embodiment, the optimization component 108 can performs an algorithmic strategy technique with respect to monitoring variables from the data group 604, the data group 608, the data group 612, the data group 616, the data group 618 and the data group 622 to determine a fraud mitigation solution for the transaction data 114.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

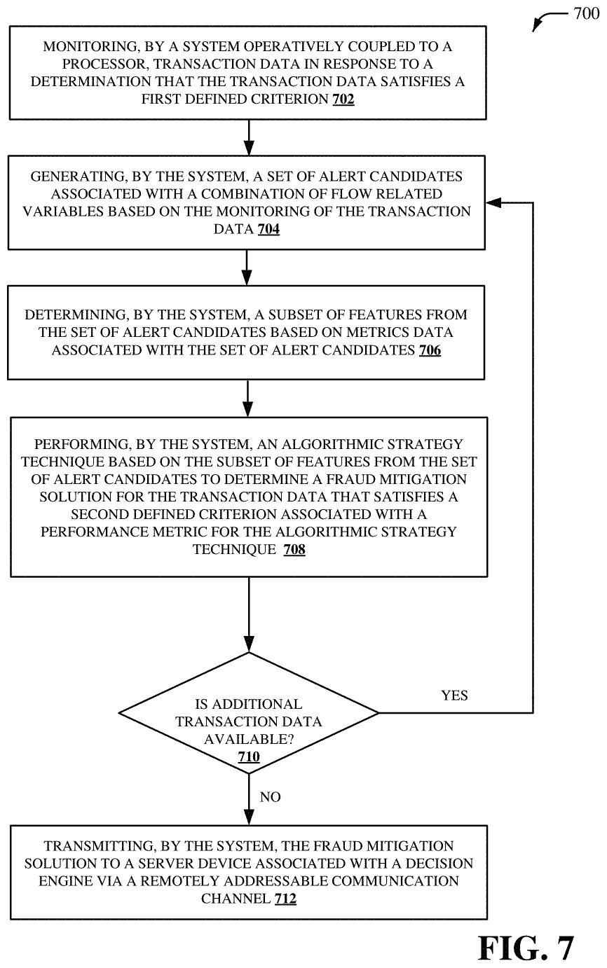

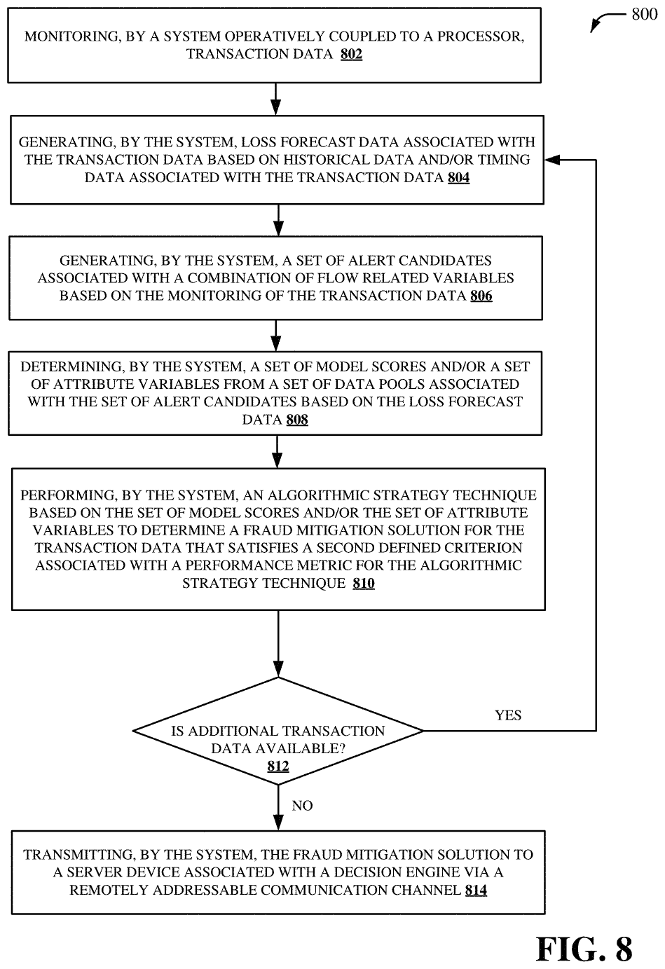

FIGS. 7-8 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device or storage media.

Referring to FIG. 7, there illustrated is a methodology 700 for providing fraud trend detection and/or loss mitigation, according to one or more embodiments of the subject innovation. As an example, the methodology 700 can be utilized in various applications, such as, but not limited to, fraud prevention systems, risk management systems, transaction systems, payment systems, online transaction systems, online payment systems, server systems, electronic device systems, mobile device systems, smartphone systems, virtual machine systems, consumer service systems, security systems, mobile application systems, financial systems, digital systems, machine learning systems, artificial intelligence systems, neural network systems, network systems, computer network systems, communication systems, enterprise systems, etc. At 702, transaction data is monitored, by a system operatively coupled to a processor (e.g., by fraud monitoring component 104), in response to a determination that the transaction data satisfies a first defined criterion. The transaction data can be data related to one or more transactions associated with one or more computing devices. The transaction data can also be associated with one or more events (e.g., one or more transaction events) associated with one or more computing devices. In an aspect, an event associated with the transaction data can include a numerical value corresponding to an amount for a transaction. Additionally or alternatively, an event associated with the transaction data can include time data related to a timestamp for the transaction. An event associated with the transaction data can additionally or alternatively include an item associated with the transaction and/or an identifier for one or more entities associated with the transaction. In certain embodiments, the transaction data can be financial transaction data. For example, the transaction data can be data to facilitate a transfer of funds for transactions between two entities. The one or more computing devices associated with the transaction data can be one or more client devices, one or more user devices, one or more electronic devices one or more mobile devices, one or more smart devices, one or more smart phones, one or more tablet devices, one or more handheld devices, one or more portable computing devices, one or more wearable devices, one or more computers, one or more desktop computers, one or more laptop computers, and/or one or more other types of electronic devices associated with a display. In an embodiment, the first defined criterion can be a criterion associated with a fraud trend. The fraud trend can be, for example, undesirable behavior associated with transaction data. For instance, the fraud trend can correspond to one or more patterns associated with the transaction data. In an aspect, a set of monitoring criteria can be employed to determine whether the transaction data satisfies the first defined criterion. For example, data values and/or patterns related to the transaction data can be monitored. In certain embodiments, the transaction data can be monitored based on historical data associated with the transaction data. Additionally or alternatively, in certain embodiments, the transaction data can be monitored based on timing data (e.g., point-in-time data) associated with the transaction data. In certain embodiments, loss forecast data associated with the historical data and/or the timing data can be generated.

At 704, a set of alert candidates associated with a combination of flow related variables is generated, by the system (e.g., by fraud monitoring component 104), based on the monitoring of the transaction data. The set of alert candidates can be, for example, alert candidates associated with alert flow decisions. For example, the set of alert candidates can be combinations of flow related variables associated with the transaction data. In certain embodiments, the set of alert candidates can be constructed as a decision tree with different combinations of flow related variables associated with the transaction data.

At 706, a subset of features from the set of alert candidates is determined, by the system (e.g., by feature selection component 106), based on metrics data associated with the set of alert candidates. The metrics data can include statistical data for the set of alert candidates. In one example, the metrics data can include a set of information values for the set of alert candidates. An information value can be, for example, a sum of values for features associated with a weight of evidence score. Additionally or alternatively, the metrics data can include a set of logistic regression values for the set of alert candidates. A logistic regression value can be, for example, a statistical value that employs a logistic function to model a portion of the set of alert candidates. Additionally or alternatively, the metrics data can include data associated with decision tree learning such as, for example, an iterative Dichotomiser 3 algorithm, a C4.5 algorithm, a classification and regression trees algorithm, and/or another decision tree learning algorithm. In certain embodiments, the subset of features can be determined from the set of alert candidates based on the loss forecast data. In certain embodiments, a set of model scores and/or a set of attribute variables can be determined from a set of data pools associated with the set of alert candidates.

At 708, an algorithmic strategy technique is performed, by the system (e.g., by optimization component 108), based on the subset of features from the set of alert candidates to determine a fraud mitigation solution for the transaction data that satisfies a second defined criterion associated with a performance metric for the algorithmic strategy technique. In an embodiment, the algorithmic strategy technique can be a greedy search algorithmic technique that employs a heuristic approach to determine optimal decisions associated with a decision tree. The fraud mitigation solution can be a solution mitigate an effect of the fraud trend on an online transaction system. For instance, the fraud mitigation solution can be one or more actions to perform to modify one or more portions of the online transaction system, thereby mitigating loss associated with the fraud trend. In certain embodiments, the algorithmic strategy technique can be performed based on the set of model scores and/or the set of attribute variables to determine the fraud mitigation solution for the transaction data.

At 710, it is determined whether additional transaction data is available. If yes, the methodology 700 returns to 704. If no, the methodology 700 proceeds to 712.

At 712, the fraud mitigation solution is transmitted, by the system (e.g., by decision engine component 202), to a server device associated with a decision engine via a remotely addressable communication channel. For example, the fraud mitigation solution can be transmitted to the server device associated with the decision engine via a remotely addressable communication channel associated with a tunneling protocol. The tunneling protocol can be associated with real-time repetitive transmission of data. The tunneling protocol can also encrypt the fraud mitigation solution. In an embodiment, the fraud mitigation solution can be transmitted to the server device associated with the decision engine via a remotely addressable communication channel. The server device associated with a decision engine can be configured to perform one or more actions associated with the fraud mitigation solution.

Referring to FIG. 8, there illustrated is a methodology 800 for providing fraud trend detection and/or loss mitigation, according to one or more embodiments of the subject innovation. As an example, the methodology 800 can be utilized in various applications, such as, but not limited to, fraud prevention systems, risk management systems, transaction systems, payment systems, online transaction systems, online payment systems, server systems, electronic device systems, mobile device systems, smartphone systems, virtual machine systems, consumer service systems, security systems, mobile application systems, financial systems, digital systems, machine learning systems, artificial intelligence systems, neural network systems, network systems, computer network systems, communication systems, enterprise systems, etc. At 802, transaction data is monitored by a system operatively coupled to a processor (e.g., by fraud monitoring component 104). The transaction data can be data related to one or more transactions associated with one or more computing devices. The transaction data can also be associated with one or more events (e.g., one or more transaction events) associated with one or more computing devices. In an aspect, an event associated with the transaction data can include a numerical value corresponding to an amount for a transaction. Additionally or alternatively, an event associated with the transaction data can include time data related to a timestamp for the transaction. An event associated with the transaction data can additionally or alternatively include an item associated with the transaction and/or an identifier for one or more entities associated with the transaction. In certain embodiments, the transaction data can be financial transaction data. For example, the transaction data can be data to facilitate a transfer of funds for transactions between two entities. The one or more computing devices associated with the transaction data can be one or more client devices, one or more user devices, one or more electronic devices one or more mobile devices, one or more smart devices, one or more smart phones, one or more tablet devices, one or more handheld devices, one or more portable computing devices, one or more wearable devices, one or more computers, one or more desktop computers, one or more laptop computers, and/or one or more other types of electronic devices associated with a display. In an embodiment, the transaction data can be monitored to determine whether the transaction data satisfies a defined criterion associated with a fraud trend. The fraud trend can be, for example, undesirable behavior associated with transaction data. For instance, the fraud trend can correspond to one or more patterns associated with the transaction data. In an aspect, a set of monitoring criteria can be employed to determine whether the transaction data satisfies the defined criterion. For example, data values and/or patterns related to the transaction data can be monitored.

At 804, loss forecast data associated with the transaction data is generated, by the system (e.g., by fraud monitoring component 104), based on historical data and/or timing data associated with the transaction data. The historical data can include historical information associated with one or more previous fraud trends. For example, the historical data can include historical values and/or historical patterns for previous transaction data associated with a fraud trend. The timing data can be related to a timing and/or information for one or more previous transactions. In one example, the timing data can be point-in-time data that provides a snapshot of previous transaction data associated with one or more previous fraud trends. For instance, the point-in-time data can be a copy of previous transaction data associated with one or more previous fraud trends.

At 806, a set of alert candidates associated with a combination of flow related variables is generated, by the system (e.g., by fraud monitoring component 104), based on the monitoring of the transaction data. The set of alert candidates can be, for example, alert candidates associated with alert flow decisions. For example, the set of alert candidates can be combinations of flow related variables associated with the transaction data. In certain embodiments, the set of alert candidates can be constructed as a decision tree with different combinations of flow related variables associated with the transaction data.

At 808, a set of model scores and/or a set of attribute variables is determined, by the system (e.g., by feature selection component 106), from a set of data pools associated with the set of alert candidates based on the loss forecast data. The set of model scores can be as set of scores for a set of models associated with the set of alert candidates. The set of attribute variables can be a set of variables from the set of alert candidates determined based on a feature selection technique. For example, the set of attribute variables can be a set of significant variables for respective alert flows determined based on a feature selection technique. In certain embodiments, the set of model scores can be determined based on metrics data for the set of alert candidates. The metrics data can include statistical data for the set of alert candidates. In one example, the metrics data can include a set of information values for the set of alert candidates. An information value can be, for example, a sum of values for features associated with a weight of evidence score. Additionally or alternatively, the metrics data can include a set of logistic regression values for the set of alert candidates. A logistic regression value can be, for example, a statistical value that employs a logistic function to model a portion of the set of alert candidates. Additionally or alternatively, the metrics data can include data associated with decision tree learning such as, for example, an iterative Dichotomiser 3 algorithm, a C4.5 algorithm, a classification and regression trees algorithm, and/or another decision tree learning algorithm.

At 810, an algorithmic strategy technique is performed, by the system (e.g., by optimization component 108), based on the set of model scores and/or the set of attribute variables to determine a fraud mitigation solution for the transaction data that satisfies a second defined criterion associated with a performance metric for the algorithmic strategy technique. In an embodiment, the algorithmic strategy technique can be a greedy search algorithmic technique that employs a heuristic approach to determine optimal decisions associated with a decision tree. The fraud mitigation solution can be a solution mitigate an effect of the fraud trend on an online transaction system. For instance, the fraud mitigation solution can be one or more actions to perform to modify one or more portions of the online transaction system, thereby mitigating loss associated with the fraud trend. In certain embodiments, the algorithmic strategy technique can be performed based on the set of model scores and/or the set of attribute variables to determine the fraud mitigation solution for the transaction data.

At 812, it is determined whether additional transaction data is available. If yes, the methodology 800 returns to 804. If no, the methodology 800 proceeds to 814.

At 814, the fraud mitigation solution is transmitted, by the system (e.g., by decision engine component 202), to a server device associated with a decision engine via a remotely addressable communication channel. For example, the fraud mitigation solution can be transmitted to the server device associated with the decision engine via a remotely addressable communication channel associated with a tunneling protocol. The tunneling protocol can be associated with real-time repetitive transmission of data. The tunneling protocol can also encrypt the fraud mitigation solution. In an embodiment, the fraud mitigation solution can be transmitted to the server device associated with the decision engine via a remotely addressable communication channel. The server device associated with a decision engine can be configured to perform one or more actions associated with the fraud mitigation solution.

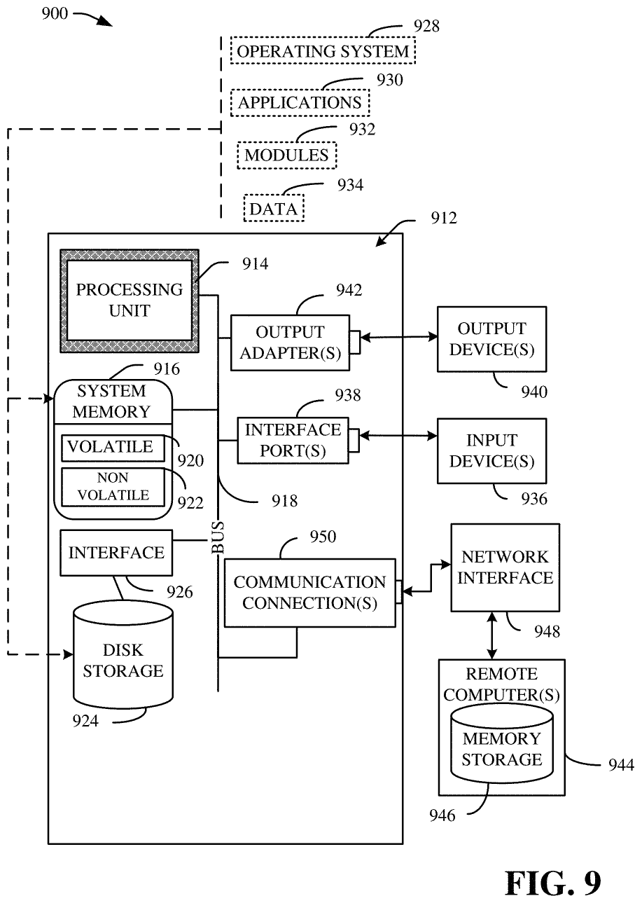

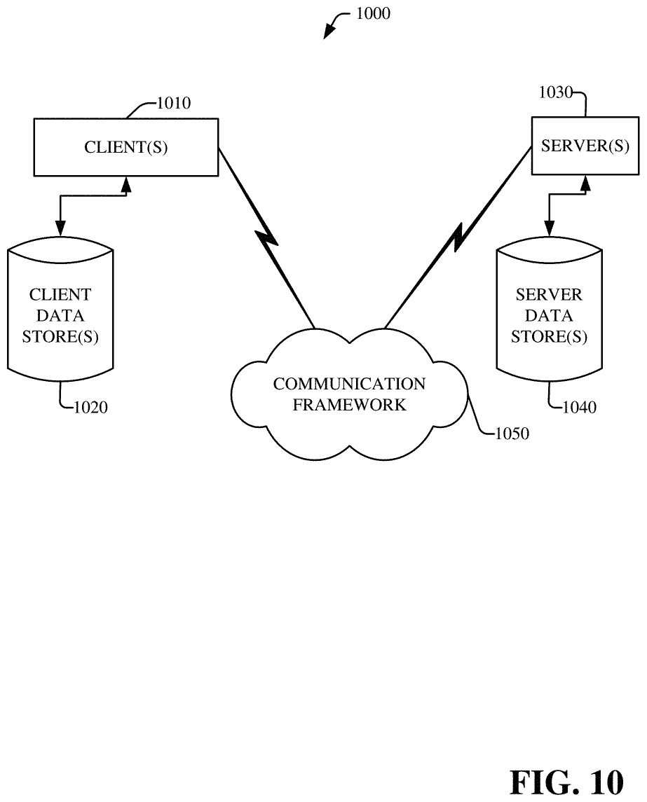

In order to provide a context for the various aspects of the disclosed subject matter, FIGS. 9 and 10 as well as the following discussion are intended to provide a brief, general description of a suitable environment in which the various aspects of the disclosed subject matter may be implemented.

With reference to FIG. 9, a suitable environment 900 for implementing various aspects of this disclosure includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 912 also includes removable/non-removable, volatile/non-volatile computer storage media. FIG. 9 illustrates, for example, a disk storage 924. Disk storage 924 includes, but is not limited to, devices like a magnetic disk drive, floppy disk drive, tape drive, Jaz drive, Zip drive, LS-100 drive, flash memory card, or memory stick. The disk storage 924 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used, such as interface 926.

FIG. 9 also depicts software that acts as an intermediary between users and the basic computer resources described in the suitable operating environment 900. Such software includes, for example, an operating system 928. Operating system 928, which can be stored on disk storage 924, acts to control and allocate resources of the computer system 912. System applications 930 take advantage of the management of resources by operating system 928 through program modules 932 and program data 934, e.g., stored either in system memory 916 or on disk storage 924. It is to be appreciated that this disclosure can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 with which the subject matter of this disclosure can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing this disclosure, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1020 that can be employed to store information local to the client(s) 1010. Similarly, the server(s) 1030 are operatively connected to one or more server data store(s) 1040 that can be employed to store information local to the servers 1030.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

It is to be appreciated and understood that components, as described with regard to a particular system or method, can include the same or similar functionality as respective components (e.g., respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a memory that stores computer executable components;
a processor that executes computer executable components stored in the memory, wherein the computer executable components comprise:
a fraud monitoring component that determines that transaction data satisfies a first defined criterion associated with a fraud trend and generates alert flow decision data based on the fraud trend;
a feature selection component that determines a subset of features from the alert flow decision data; and
an optimization component that performs an algorithmic strategy technique based on the subset of features from the alert flow decision data to determine a fraud mitigation solution for the transaction data that satisfies a second defined criterion associated with a performance metric for the algorithmic strategy technique.

2. The system of claim 1, wherein the fraud monitoring component generates loss forecast data associated with the fraud trend based on historical data and point-in-time data associated with the transaction data.

3. The system of claim 2, wherein the feature selection component determines the subset of features from the alert flow decision data based on the loss forecast data.

4. The system of claim 1, wherein the feature selection component determines a set of model scores and a set of attribute variables from a set of data pools associated with the alert flow decision data.

5. The system of claim 4, wherein the optimization component performs the algorithmic strategy technique based on the set of model scores and the set of attribute variables to determine the fraud mitigation solution for the transaction data.

6. The system of claim 1, wherein the optimization component performs a greedy search algorithmic technique based on the subset of features from the alert flow decision data to determine the fraud mitigation solution for the transaction data.

7. The system of claim 1, wherein the computer executable components comprise:
a decision engine component that transmits the fraud mitigation solution to a server associated with a decision engine via a data channel associated with a tunneling protocol.

8. The system of claim 7, wherein the decision engine component transmits the fraud mitigation solution to the server associated with the decision engine via a remotely addressable communication channel.

9. The system of claim 7, wherein the decision engine component further transmits the alert flow decision data to the server associated with the decision engine via the data channel associated with the tunneling protocol.

10. A computer-implemented method, comprising:
monitoring, by a system operatively coupled to a processor, transaction data in response to a determination that the transaction data satisfies a first defined criterion;
generating, by the system, a set of alert candidates associated with a combination of flow related variables based on the monitoring of the transaction data;
determining, by the system, a subset of features from the set of alert candidates based on metrics data associated with the set of alert candidates; and
performing, by the system, an algorithmic strategy technique based on the subset of features from the set of alert candidates to determine a fraud mitigation solution for the transaction data that satisfies a second defined criterion associated with a performance metric for the algorithmic strategy technique.

11. The computer-implemented method of claim 10, wherein the monitoring comprises generating loss forecast data associated with the transaction data based on historical data and timing data associated with the transaction data.

12. The computer-implemented method of claim 11, wherein the determining comprises determining the subset of features from the set of alert candidates based on the loss forecast data.

13. The computer-implemented method of claim 10, wherein the determining comprises determining a set of model scores and a set of attribute variables from a set of data pools associated with the set of alert candidates.

14. The computer-implemented method of claim 13, wherein the performing comprises performing the algorithmic strategy technique based on the set of model scores and the set of attribute variables to determine the fraud mitigation solution for the transaction data.

15. The computer-implemented method of claim 10, wherein the performing comprises performing a greedy search algorithmic technique.

16. The computer-implemented method of claim 10, further comprising:
transmitting, by the system, the fraud mitigation solution to a server associated with a decision engine via a remotely addressable communication channel.

17. A computer readable storage device comprising instructions that, in response to execution, cause a system comprising a processor to perform operations, comprising:
generating a set of alert candidates associated with a set of flow related variables for transaction data based on monitoring data associated with the transaction data;
determining a subset of features from the set of alert candidates based on metrics data associated with the set of alert candidates;
performing an algorithmic strategy technique based on the subset of features from the set of alert candidates to determine a fraud mitigation solution for the transaction data that satisfies a defined criterion associated with a performance metric for the algorithmic strategy technique; and
transmitting the fraud mitigation solution to a server device associated with a decision engine via a secure communication channel.

18. The computer readable storage device of claim 17, wherein the operations further comprise:
generating loss forecast data associated with the transaction data based on historical data and timing data associated with the transaction data.

19. The computer readable storage device of claim 18, wherein the determining comprises determining the subset of features from the set of alert candidates based on the loss forecast data.

20. The computer readable storage device of claim 17, wherein the determining comprises determining a set of model scores from a set of data pools associated with the set of alert candidates.
